(19) United States
(12) Patent Application Publication
(10) Pub. No.: US 2026/0310601 A1
(43) Pub. Date: Oct. 8, 2026

(54) Cache Memory Optimization System Based on Importance

(71) Applicant: Jiwon Lee, Seongnam-si (KR)

(72) Inventor: Jiwon Lee, Seongnam-si (KR)

(21) Appl. No.: 19/540,909

(22) Filed: Feb. 16, 2026

(30) Foreign Application Priority Data
Apr. 3, 2025 (KR) 1020250043352

(51) Int. Cl. G06F 12/0802

(52) U.S. Cl. CPC G06F 12/0802; G06F 2212/60

(57) ABSTRACT

A cache flow control system optimizes cache memory management through importance-based data classification. The system receives and analyzes user input data in real-time to evaluate information importance, repeatability, and flow conflicts. Data is classified into four priority groups: S group (core information completely preserved), A group (important information maintained with summarization), B group (auxiliary information subject to compression or deletion), and C group (incidental information discarded in real-time). Group-specific processing rules apply differential treatment: S group preservation, A group summarization, B group compression/deletion, and C group disposal. A memory update unit stores processed information in optimized form in cache memory.

The system includes context restoration mechanisms to maintain logical continuity when retrieving compressed or deleted information, achieving efficient cache utilization while preserving informational value.

### CROSS-REFERENCE TO RELATED APPLICATIONS

This application claims priority to Korean Patent Application No. 10-2025-0043352, filed on Apr. 3, 2025, the entire contents of which are incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present invention relates generally to cache memory management systems, and more particularly to a system and method for optimizing cache flow control through importance-based data classification with continuous learning and dynamic adaptation capabilities.

### Description of the Related Art

Cache memory management directly impacts system performance and response times. Conventional cache management techniques use LRU (Least Recently Used) or LFU (Least Frequently Used) algorithms to determine which data to retain and which to evict from cache memory.

However, these conventional techniques have limitations. LRU-based systems prioritize recently accessed data and evict older data. However, important information entered early in a session (project requirements, user preferences, etc.) may remain highly relevant regardless of recent access. LFU-based systems prioritize frequently accessed data but cannot distinguish between high-value and low-value operations.

A key deficiency of conventional techniques is the inability to manage data based on actual importance. In conversational AI systems, early conversation context may be evicted, requiring users to repeatedly re-enter information. In medical systems, patient allergy information may be evicted under load conditions. In e-commerce platforms, high-value and low-value products cannot be distinguished.

Additionally, machine learning approaches to cache optimization face the cold start problem. Without sufficient training data, performance is difficult to achieve, and important data may be evicted during the initial learning period. Pure automated approaches lack user control, making it difficult to ensure priority for important data.

Additionally, conventional cache management systems cannot adapt to changing usage patterns. When data importance changes over time, static algorithms cannot adjust cache priorities.

Conventional cache management systems fail to manage repetitive information effectively. When users repeatedly input similar queries, each instance is stored separately, wasting memory.

Therefore, a cache management system is needed that: (1) enables users to explicitly specify data importance; (2) solves the cold start problem through user classification; (3) includes learning mechanisms that progressively automate classification; (4) dynamically adapts to changing usage patterns; (5) provides user control over classification decisions.

The present invention addresses these needs through an importance-based classification system.

### BRIEF SUMMARY OF THE INVENTION

The present invention provides a cache flow control system that optimizes cache memory management through importance-based data classification, continuous learning from user input, and dynamic adaptation to changing usage patterns.

In accordance with one aspect of the invention, a cache flow control system comprises: an input unit for receiving data; a cache memory evaluation unit for analyzing data characteristics; and a priority evaluation unit for classifying data into importance-based priority groups.

The system classifies data into S (Superior), A (Advanced), B (Basic), and C (Complementary) groups. S group data is fully preserved, A group data is preserved with summarization, B group data is subject to conditional compression/deletion, and C group data is subject to immediate disposal. Each group receives differential treatment in cache retention policies and memory allocation.

The invention includes a continuous learning mechanism that accumulates user classification decisions and learns patterns. When users classify data into importance groups, the system records these classifications along with data characteristics. After accumulating sufficient examples, the system analyzes patterns between data features and group assignments, enabling automatic classification of similar items.

This learning approach solves the cold start problem by leveraging initial user classifications. As the classification history grows, the system becomes progressively automated. User corrections to automated classifications are fed back into the learning system, continuously refining classification accuracy.

The invention further incorporates dynamic reclassification mechanisms that monitor usage patterns and automatically adjust group assignments as data importance changes. The priority group assignment unit tracks access frequency and temporal patterns for data in each group. When usage pattern changes are detected, the dynamic adjustment module adjusts group assignments.

For example, when data classified as S group exhibits declining access frequency over multiple weeks, the system may reclassify it to A or B group, freeing high-priority cache space for actively used data. Conversely, when data in lower-priority groups exhibits increased importance through elevated access frequency or changing business context, the system automatically promotes it to higher-priority groups, ensuring immediate availability without manual intervention.

The system also implements adaptive memory allocation that dynamically adjusts the distribution of cache memory among priority groups based on actual group populations and access patterns. As reclassification operations change group compositions, memory resources are automatically reallocated to maintain optimal cache utilization, concentrating memory on high-importance groups while minimizing allocation to low-importance groups.

The invention provides the following advantages over prior art:

First, importance-based classification improves cache efficiency by determining cache retention based on actual data value.
Second, the continuous learning mechanism solves the cold start problem by providing immediate effectiveness through user classifications while progressively automating.
Third, dynamic reclassification automatically adapts to changing usage patterns, maintaining the system in an optimal state.
Fourth, it can reduce memory requirements by approximately 49-67% compared to existing approaches while maintaining performance levels.
Fifth, the system maintains a balance between user control and automation by automating routine classifications while allowing explicit classification of critical data.

The invention is applicable across diverse domains including conversational AI systems, database caching, mobile computing, and e-commerce platforms. The real-time parallel processing architecture of the present invention implements simultaneous importance evaluation across multiple criteria, unlike conventional approaches that rely on historical access patterns.

Other objects, features, and advantages of the present invention will become apparent from the following detailed description, the accompanying drawings, and the appended claims.

### BRIEF DESCRIPTION OF THE DRAWINGS

FIG. 1 is a block diagram illustrating an overall structure of a cache flow control system utilizing S/A/B/C group classification according to an embodiment of the present invention.

FIG. 2 is a flowchart illustrating a priority-based cache management process according to an embodiment of the present invention.

FIG. 3 is a flowchart illustrating a context-based restoration process during cache restoration according to an embodiment of the present invention.

### DETAILED DESCRIPTION OF THE INVENTION

The following detailed description presents the invention through various aspects including system architecture, classification mechanisms, learning processes, dynamic adaptation, context restoration, and implementation considerations. The embodiments described hereinafter are illustrative examples to aid understanding of the present invention, and the scope of the invention is not limited thereto.

### 10.1 System Architecture Overview

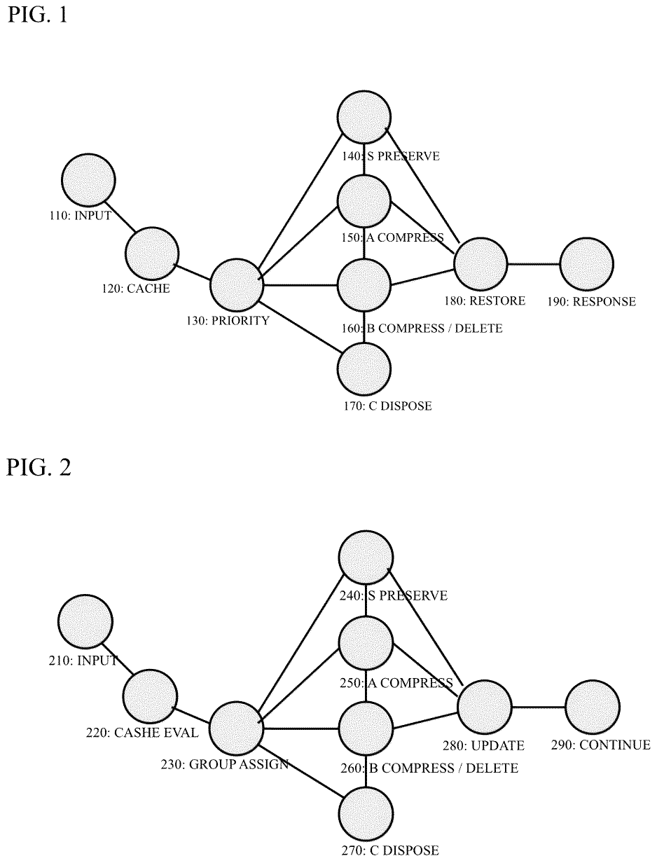

Referring to FIG. 1, a cache flow control system 100 according to an embodiment of the present invention comprises: a user input unit 110; a cache memory unit 120; a priority evaluation unit 130; group-specific processing units (140, 150, 160, 170) for differential treatment based on importance classification; a context restoration unit 180; and a response generation unit 190. These components operate in coordination to implement importance-based cache management with progressive learning and dynamic adaptation capabilities, enabling efficient memory utilization while maintaining response quality across diverse deployment domains.

The user input unit 110 receives input data including text, commands, queries, and domain-specific information, performing preprocessing and assigning unique identifiers for tracking purposes. The cache memory unit 120 maintains structured storage with metadata tracking for each data element, implementing separate logical partitions for different priority groups to enable differential treatment. The priority evaluation unit 130 analyzes data importance in real-time using multiple criteria including semantic value, temporal relevance, usage frequency, and user explicit indicators, implementing both rule-based mechanisms for immediate effectiveness and learning-based mechanisms that progressively improve accuracy through pattern recognition.

The system implements four group-specific processing units that apply differential treatment strategies based on importance classification. Each processing unit is optimized for its designated priority group, balancing retention value against resource consumption to maximize overall cache efficiency while ensuring critical data preservation.

The S group preservation processing unit 140 completely preserves core information without compression or deletion, ensuring highest priority in cache retention and allocation to fastest storage tiers. S group data includes user-designated critical information, safety-critical data, high-value business content, and foundational context essential for operational continuity. The A group compression processing unit 150 applies intelligent summarization while maintaining content integrity, using natural language processing or domain-appropriate algorithms to extract essential elements and reconstruct them in compressed form that preserves informational value while reducing storage requirements.

The B group compression/deletion processing unit 160 applies aggressive processing including partial compression or selective deletion depending on capacity constraints, considering retention value and cache space efficiency to determine the processing method. The C group disposal processing unit 170 implements immediate removal of low-priority transient information including repetitive content, acknowledgments, and temporary results, while maintaining lightweight metadata for pattern analysis purposes such as tracking repetition frequencies.

The context restoration unit 180 restores previously compressed or deleted information when required, applying appropriate strategies based on priority classification: complete restoration for S group data, summary-based restoration for A group data, selective restoration for B group data, and graceful handling for C group data through contextual inference. The unit generates transitional phrases and linking information to maintain logical flow even when information has been compressed or deleted. The response generation unit 190 constructs responses using optimized cache information, prioritizing S group content as foundation while appropriately incorporating A and B group information based on relevance and availability, operating transparently to deliver high-quality responses without exposing underlying optimization operations.

These components operate in integrated workflow: input flows through the input unit (110) to cache memory (120) and priority evaluation (130); the evaluation unit classifies data and directs it to appropriate processing units (140-170); processed data is stored with priority metadata; when information is needed, the response generation unit (190) retrieves from cache memory (120) and invokes context restoration (180) as needed; the completed response is delivered to the user. This architecture enables efficient cache utilization while maintaining response quality across deployment domains.

### 10.2 S/A/B/C Classification Mechanism

The cache flow control system implements a hierarchical importance-based classification mechanism that assigns data to four distinct priority groups: S (Superior), A (Advanced), B (Basic), and C (Complementary). This classification framework enables differential treatment of cached data based on actual importance rather than simple temporal or frequency metrics, addressing the fundamental limitations of conventional LRU and LFU approaches.

The priority evaluation unit 130 may evaluate data importance using multiple complementary criteria: (1) Semantic Importance analyzes key concepts, critical facts, and essential knowledge using natural language processing techniques; (2) Temporal Relevance evaluates recency and temporal continuity while considering other factors unlike pure LRU approaches; (3) Usage Frequency distinguishes high-value frequent access from low-value repetitive operations to avoid cache pollution; (4) Contextual Importance assesses relevance to current operational context and active workflows; and (5) User Explicit Indication respects user-designated importance through direct commands or implicit signals, overriding automated assessments. For example, in conversational AI systems, user statements of project requirements may receive high semantic importance scores, while in medical systems, patient allergy information may receive maximum contextual importance during emergency encounters regardless of access frequency.

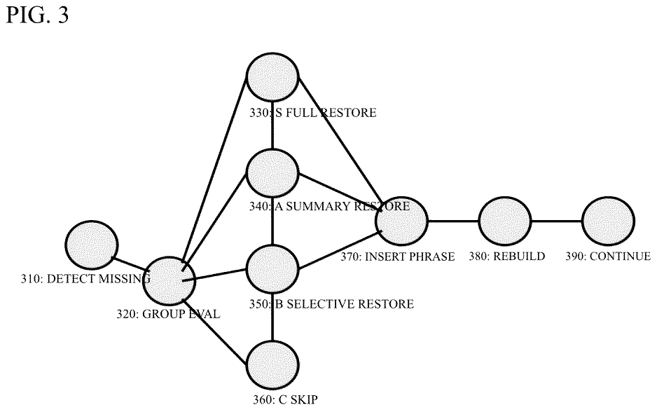

Based on these evaluation criteria, the priority evaluation unit assigns each data element an importance score and classifies it into one of the four priority groups. Referring to FIG. 2, the classification process proceeds as follows: user input (210) enters the system; cache entry evaluation (220) analyzes the data using the criteria described above; priority group allocation (230) assigns the data to the appropriate S/A/B/C group based on evaluation results; and group-specific processing (240-270) applies differential treatment according to group classification.

S Group (Superior) contains the most critical data essential for system operation, receiving complete preservation without compression or deletion. S group classification includes user-stated objectives and constraints, key decisions, safety-critical information (medical allergies, active medications), high-value business data, and foundational operational context. As shown in FIG. 2, S group data (240) is preserved with maximum protection and allocated to fastest storage tiers. A Group (Advanced) contains important contextual information that tolerates intelligent summarization when capacity optimization is needed, including recent conversational exchanges, background information, user preferences, technical specifications, and reference data supporting ongoing tasks. A group data (250) may undergo conservative compression achieving, for example, approximately 40-60% size reduction while maintaining informational integrity.

B Group (Basic) contains auxiliary information supporting main content but not essential for core operations, including supporting details, historical information, resolved issues, and general reference data. B group data (260) receives aggressive compression or partial deletion based on capacity requirements, with consideration of retention value and cache space efficiency. C Group (Complementary) contains transient low-priority information with minimal retention value, including repetitive information, acknowledgments, temporary results, and outdated content. As shown in FIG. 2, C group data (270) is discarded immediately, though lightweight metadata may be maintained for pattern analysis purposes.

The system includes a compression analysis module that evaluates data characteristics to determine optimal compression strategies for B group data. The module analyzes repetition patterns, information distribution, and data structure complexity to select appropriate compression algorithms. An adaptive compression mechanism dynamically adjusts compression strength based on system resource availability-applying aggressive compression during high memory pressure and lighter compression when resources are abundant. The compression evaluation metrics include data entropy, redundancy levels, access frequency patterns, and expected retrieval probability, ensuring that compression decisions balance storage efficiency with reconstruction performance.

The system adapts data placement strategies to different cache architectures. In hierarchical cache structures, S group data resides in highest-level cache (L1) for immediate access, A group data occupies mid-level cache (L2), B group data utilizes lower-level cache (L3), while C group data bypasses cache entirely. In distributed cache architectures, S and A group data replicates across all nodes for high availability, B group data caches selectively based on access patterns, and C group data uses only temporary node-local storage. In unified cache architectures, memory allocation adjusts dynamically according to S/A/B/C importance ratios. In one embodiment, the system may maintain, for example, approximately 30-40% for S group, 25-35% for A group, 20-30% for B group, and 5-10% for temporary C group processing, though these allocation ratios may vary depending on specific deployment requirements.

The differential processing strategies create a memory allocation hierarchy concentrating resources on high-value information. In typical deployments, S group data (representing, for example, approximately 5-15% of items) may receive approximately 30-40% of cache allocation; A group data (approximately 20-30% of items) may receive approximately 40-50%; B group data (approximately 30-40% of items) may receive approximately 10-20%; and C group data receives zero allocation with immediate discard. These allocation ratios may vary depending on specific deployment requirements. After group-specific processing, the system proceeds with memory update (280) and information flow continuation (290). The classification mechanism operates continuously with periodic re-evaluation enabling dynamic reclassification as importance evolves.

Repetitive Pattern Detection and Management: The priority evaluation unit 130 implements repetitive pattern detection to prevent cache memory waste from redundant information. When users input similar or identical queries across multiple sessions, the system analyzes similarity using exact string matching, fuzzy matching, semantic similarity analysis, and temporal pattern recognition. The first instance is classified according to actual importance using standard criteria, while subsequent repetitive instances are automatically classified as C group and immediately discarded regardless of original content importance. For example, when a customer service chatbot user repeatedly asks “What are your business hours?” the first instance may be classified as B group, but subsequent identical queries are automatically discarded as C group, preventing cache waste while preserving the original informational value.

The system maintains statistical metadata about repetition patterns even when discarding instances, tracking repetition frequency to inform future importance assessments and identify information for permanent caching or proactive presentation. Importantly, the system recognizes when apparently repetitive information contains new content or changed context, performing appropriate re-evaluation rather than automatic C Group classification to ensure flexible response to genuinely new information. This combination of importance-based classification and repetition pattern management can achieve, for example, approximately 49-67% memory savings compared to traditional caching approaches depending on specific deployment characteristics and data patterns, while maintaining or exceeding cache hit rates and response quality.

### 10.3 Progressive Optimization Through Adaptive Learning

The present invention implements a progressive optimization approach that evolves over time through adaptive learning mechanisms, enabling the system to transition from initial rule-based operation to increasingly autonomous classification without requiring extensive training data at deployment. This evolutionary capability solves the cold start problem inherent in pure machine learning approaches while progressively reducing manual classification effort as operational experience accumulates.

The progressive optimization mechanism operates through four distinct phases: Initial Configuration Phase providing immediate rule-based functionality; Learning and Pattern Recognition Phase analyzing accumulated classification history; Automated Optimization Phase implementing predominantly autonomous operation; and Continuous Improvement Phase refining performance through ongoing learning. Each phase builds upon the foundation established by previous phases, creating a smooth trajectory from manual operation to highly automated intelligent optimization.

### 10.3.1 Initial Configuration Phase

The present invention employs a progressive automation approach starting from user classification to solve the cold start problem. Upon initial deployment, the system operates without historical training data, with users directly classifying data into S/A/B/C groups. The system records these user classification decisions along with data characteristics, and learns patterns based on accumulated classification history to become progressively automated. This approach provides a practical solution that delivers immediate functionality from the start while reducing user intervention over time.

The Initial Configuration Phase typically extends for the first several days to weeks of operation, continuing until sufficient classification examples accumulate to enable meaningful pattern analysis. For example, approximately 100-500 classified items may provide adequate foundation for initiating the learning phase, though this number may vary depending on domain complexity and data diversity.

### 10.3.2 Learning and Pattern Recognition Phase

As operational data accumulates, the system transitions into the Learning and Pattern Recognition Phase, wherein the priority evaluation unit 130 analyzes accumulated classification history to identify patterns correlating data features with group assignments. The pattern analysis mechanism examines feature-classification correlation, contextual pattern recognition, temporal pattern analysis, and user behavior pattern learning, creating classification rules with associated confidence scores reflecting the strength and consistency of observed patterns. For example, the system may identify patterns such as: pharmaceutical terminology consistently classified as S group with high confidence; expensive database queries (execution time>2 seconds) classified as S group; greeting phrases classified as C group with high confidence; and high-frequency recent access indicating A or S group classification. Confidence levels may vary depending on data consistency and pattern clarity.

As confidence scores for learned patterns reach predetermined thresholds, the priority evaluation unit 130 begins applying these patterns to automatically classify new data. High confidence patterns may proceed to automatic classification without user confirmation; medium confidence patterns may be applied automatically with periodic review or presented for user confirmation; and low confidence patterns are not applied automatically but may be presented as suggestions while additional data accumulates. The learning progression typically evolves over a period of weeks to months: initial manual classification by users establishes baseline patterns; pattern recognition and suggestion phase builds confidence through user confirmation; automated classification begins for high-confidence patterns; and the system progressively achieves higher levels of automation while users focus on edge cases.

Critically, the learning mechanism incorporates user feedback with elevated priority. When users correct automated classifications—through explicit reclassification or behavioral indicators—the feedback integration mechanism records corrections with higher weight in the learning model, creating a feedback loop where classification errors are quickly corrected and similar errors are prevented in the future.

### 10.3.3 Automated Optimization Phase

As sufficient operational data accumulates and learned patterns achieve high confidence, the system transitions into the Automated Optimization Phase characterized by autonomous operation with minimal ongoing user intervention. The dynamic adjustment module continuously monitors system state parameters including system load status, data access patterns, user activity patterns, and performance metrics, performing automatic optimization operations based on this real-time monitoring.

The dynamic adjustment module implements boundary value adjustment and adaptive memory allocation. Boundary value adjustment automatically adjusts importance score thresholds determining group boundaries in response to observed usage patterns. For example, based on analysis of classification decisions and actual access patterns, the following adjustments may occur: when certain A group data exhibits high access frequency similar to S group data, it is reclassified upward to S group; when certain B group data exhibits increasing importance, it is promoted to A group; and when certain B group data exhibits persistently low access frequency, it is reclassified to C group to free cache space. Adaptive memory allocation dynamically adjusts the distribution of cache memory among priority groups based on actual group populations and access patterns, automatically reallocating resources upon detecting sustained pattern changes to enable optimal cache utilization throughout varying operational conditions.

During the Automated Optimization Phase, the system automatically classifies routine data and flags only exceptional or ambiguous cases for user review. This minimizes the user's classification burden.

### 10.3.4 Continuous Improvement Phase

In the mature operational stage, the system exhibits continuous improvement characteristics wherein performance progressively enhances over extended operation through accumulated learning and ongoing optimization. The continuous improvement mechanism operates through multiple feedback loops: classification accuracy refinement comparing automated decisions against actual usage patterns; performance-driven optimization identifying opportunities through trend analysis; edge case learning incorporating unusual situations into learned knowledge; and predictive adaptation anticipating future usage patterns based on historical trends.

The cumulative effect of continuous improvement creates a performance trajectory characterized by steady long-term enhancement. Over extended operation periods, the system may demonstrate progressive improvements in cache hit rate, classification accuracy, reduction in manual classification effort, response time, and memory efficiency. Representative performance metrics are detailed in the exemplary embodiments in Sections 10.7-10.10. These performance improvements result from the system's accumulated learning, refined classification rules, optimized boundary thresholds, and adaptive memory allocation strategies that continuously evolve based on actual operational experience.

The progressive optimization approach provides the following advantages. First, rule-based initial configuration enables immediate deployment from day one. Second, user intervention decreases as the system progressively automates from initial manual classification. Third, classification accuracy continuously improves through user feedback integration. Fourth, the system automatically adapts to changing usage patterns. This combination of immediate effectiveness and long-term optimization represents a key feature of the present invention, enabling practical deployment in diverse environments.

### 10.4 Dynamic Adaptation and Reclassification

The cache flow control system implements dynamic adaptation mechanisms that continuously monitor actual usage patterns and automatically adjust priority group assignments as data importance evolves over time. Unlike static classification systems that maintain fixed assignments regardless of changing conditions, the dynamic reclassification capability enables the system to respond intelligently to shifting usage patterns, changing business priorities, and evolving operational contexts without requiring manual intervention or system reconfiguration.

The dynamic adaptation mechanism operates through continuous real-time monitoring of multiple data characteristic indicators including access frequency patterns, recent usage timing, usage context, and performance impact. Based on this monitoring, the dynamic adjustment module initiates reclassification evaluation when sustained changes in usage patterns are detected. The reclassification process distinguishes between temporary fluctuations and genuine importance shifts by requiring sustained pattern changes over predetermined observation periods before triggering reclassification, preventing unnecessary churn from transient access spikes while ensuring responsive adaptation to genuine importance changes.

### 10.4.1 Downward Reclassification

Downward reclassification occurs when data initially classified in higher-priority groups exhibits declining importance indicators over sustained periods, including declining access frequency, increasing intervals between accesses, reduced contextual relevance, and diminishing performance impact. When declining patterns are detected, the system performs systematic reclassification evaluation through historical trend analysis, future access pattern projection, importance score recalculation, boundary threshold comparison, and reclassification execution. For example, in one embodiment, when project-critical data exhibits sustained access frequency decline over a period of weeks—such as from multiple daily accesses to infrequent access—the system may recalculate importance scores and reclassify from S group to A group, freeing high-priority cache space for currently critical information while retaining the data in compressed form.

Downward reclassification prevents obsolete or declining-importance data from occupying high-priority cache resources, maintaining system efficiency by concentrating premium cache space on currently critical information. The gradual nature of reclassification—from S to A, or A to B—ensures that important information transitions through intermediate retention strategies as its value diminishes rather than being abruptly discarded.

### 10.4.2 Upward Reclassification

Upward reclassification occurs when data in lower-priority groups exhibits increasing importance indicators. Increasing importance indicators include rising access frequency, enhanced contextual relevance, and explicit user signals. For example, when reference documents classified as B group increase from weekly access to multiple daily accesses due to active project requirements, the system progressively promotes them to A group and subsequently to S group.

Upward reclassification proceeds more rapidly than downward reclassification. Newly important data can be promoted within days or hours when strong importance signals are detected, while established important data is not easily demoted based on temporary access decreases. This asymmetry enables optimal response to dynamic importance changes.

### 10.4.3 Adaptive Memory Allocation

As data moves between groups through reclassification, the relative populations of S/A/B/C groups change, requiring memory allocation adjustments. The system continuously monitors group populations and access patterns, automatically adjusting cache memory distribution. When S group data increases, S group allocation is expanded and other group allocations are adjusted to maintain cache hit rates.

Memory reallocation operates gradually rather than abruptly to maintain cache stability. When overall cache utilization approaches maximum capacity and memory pressure increases, the system performs more aggressive compression or C group disposal.

The combination of dynamic reclassification and adaptive memory allocation creates a self-optimizing system that automatically maintains optimal cache resource distribution across varying operational conditions and usage patterns. This enables automatic adaptation to changing usage patterns without manual intervention.

### 10.5 Context Restoration and Flow Continuity

Referring to FIG. 3, the context restoration unit (180) performs operations to maintain logical flow and contextual coherence when compressed or deleted information requires restoration. This mechanism ensures that aggressive cache management does not result in discontinuities or contextual gaps from the user's perspective.

The context restoration process begins with missing context detection (310), identifying that required information is not available in active cache or is stored in compressed form. Priority group evaluation (320) then determines the appropriate restoration strategy. Restoration strategies vary by group: S group receives complete restoration; A group is restored with summary information; B group undergoes selective restoration; C group is skipped.

The context restoration unit (180) performs contextual linking operations beyond simple data retrieval. The system analyzes relationships between restored information and current context, generating phrases through transition phrase insertion (370) to bridge gaps. In context reconstruction (380), retrieved data, transition phrases, and available context are combined to generate coherent responses.

For example, in a travel planning conversation where a user mentions “I want to visit Paris in spring” (S group), “preference for boutique hotels in central locations” (A group), and after discussing several hotels (compressed as B group) asks “What about transportation?”, the context restoration unit identifies relevant context. Without restoration, only generic transportation information would be provided, but with context restoration, the system generates responses reflecting context such as “Regarding transportation for your spring Paris trip, given your preference for central locations, I recommend focusing on Metro access to areas like Le Marais and Saint-Germain.”

The context restoration unit automatically generates appropriate transition phrases based on gap types. Templates such as temporal references (“Following up on our previous discussion . . . ”), topic transitions (“Regarding [topic] . . . ”), and clarifying summaries (“Based on your stated preferences . . . ”) are used to select phrases appropriate for specific restoration scenarios.

Transition phrases serve dual purposes: providing contextual links helping users follow logical flow, and transparently handling gaps created by cache optimization. When perfect restoration is impossible, the system prioritizes maintaining conversational coherence while gracefully acknowledging information limits rather than fabricating content.

### 10.6 Computational Efficiency of Four-Tier Classification

The four-tier classification structure (S/A/B/C groups) provides computational efficiency due to alignment with binary computer architecture. The four priority groups can be represented using exactly 2 bits of storage (2²=4 possible values), enabling efficient encoding and processing. This power-of-two structure enables fast priority determination operations and efficient memory utilization.

The four-tier structure also provides a balance between practical usability and technical efficiency. Four priority levels provide sufficient differentiation without excessive complexity. The classification aligns with intuitive importance distinctions: “essential” (S group), “important” (A group), “supplementary” (B group), and “transient” (C group). This structure facilitates user classification while enabling efficient implementation.

### 10.7 Embodiment 1: Conversational AI System

### 10.7.1 System Configuration

In this exemplary embodiment, the cache flow control system is deployed in a conversational AI system (such as a large language model chatbot or virtual assistant) that manages extended conversation sessions with users. The system addresses the challenge of maintaining relevant conversational context within limited memory while ensuring response quality and coherence.

### 10.7.2 Classification Distribution

The priority evaluation unit (130) classifies conversation data based on conversational characteristics. For example, in one deployment:
S Group (~15%): User-stated goals and requirements, critical decision points, explicitly requested information retention, and fundamental project context
A Group (~20%): Recent conversation exchanges (last 10-20 interactions), user preferences and patterns, technical specifications, and actively referenced information
B Group (~30%): Supporting details, resolved sub-topics, and general conversational context beyond immediate relevance
C Group (~35%): Acknowledgments, confirmations, off-topic content, and repetitive information
   These distribution percentages are exemplary and may vary based on specific conversation patterns and user requirements.

### 10.7.3 Memory Savings Calculation

Applying differential processing strategies to the above distribution, memory savings are calculated as follows:

| Group | Population | Processing Strategy | Calculation | Savings |
|---|---|---|---|---|
| S Group | 15% | Full preservation | 15% × 0% | 0% |
| A Group | 20% | 20-30% compression | 20% × 25% | 5% |
| B Group | 30% | 50-70% compression | 30% × 60% | 18% |
| C Group | 35% | Complete discard | 35% × 100% | 35% |
| Total | 100% | | | 58% |

With aggressive B Group compression (70%), total memory savings can reach:
B Group contribution: 30%×70%=21%
Total: 0%+5%+21%+35%=61%
   In highly optimized deployments with maximum compression rates (A: 30%, B: 70%), memory savings can reach approximately 62%.

### 10.7.4 Response Time Improvement

In conversational AI systems, cache miss penalty is typically 10× cache hit latency due to context retrieval and processing overhead. Response time improvement can be calculated using the following formula:
Baseline average latency: L₁=H₁(1)+(1−H₁)(10)
Optimized average latency: L₂=H₂(1)+(1−H₂)(10)
Improvement: (L₁−L₂)/L₁
   For example, if importance-based classification improves hit rate by 30 percentage points:

| Baseline Hit | Optimized Hit | Baseline | Optimized | |
|---|---|---|---|---|
| Rate (H₁) | Rate (H₂) | Latency | Latency | Improvement |
| 50% | 80% | 5.5 units | 2.8 units | 49% |
| 60% | 90% | 4.6 units | 1.9 units | 59% |
| 70% | 100% | 3.7 units | 1.0 units | 73% |

Actual improvement varies based on baseline hit rate and system-specific cache miss penalty.

### 10.7.5 Summary

This embodiment demonstrates the invention applied to conversational AI:
1. Classification: Conversation elements distributed into S/A/B/C groups based on conversational importance
2. Differential processing: Critical context preserved; acknowledgments and repetitive content discarded
3. Memory savings: Calculated savings of approximately 58-62% based on group distribution and compression rates
4. Response time: Improvements derived directly from cache hit rate enhancement, achieving 49-73% improvement depending on baseline hit rate
   The calculation methodology provides a systematic framework for estimating performance improvements across various deployment configurations.

### 10.8 Embodiment 2: Database Caching System

### 10.8.1 System Configuration

In this exemplary embodiment, the cache flow control system is deployed in a database caching layer serving high-traffic web applications. The system applies S/A/B/C classification to query results and database objects, reducing database load while maintaining data freshness for critical operations.

### 10.8.2 Classification Distribution

The priority evaluation unit (130) classifies database cache entries based on query characteristics. For example, in one deployment:
S Group (~10%): Authentication data, active session state, frequently-joined reference tables (lower percentage as authentication data occupies small space)
A Group (~25%): Recent query results, user profile data, active transaction context
B Group (~35%): Historical reports, archived records, infrequently-accessed lookups
C Group (~30%): Expired session data, temporary calculation results, superseded cache entries
   These distribution percentages are exemplary and may vary based on specific database workloads and access patterns.

### 10.8.3 Memory Savings Calculation

Applying differential processing strategies to the above distribution, memory savings are calculated as follows:

| Group | Population | Processing Strategy | Calculation | Savings |
|---|---|---|---|---|
| S Group | 10% | Full preservation | 10% × 0% | 0% |
| A Group | 25% | 20-30% compression | 25% × 25% | 6.25% |
| B Group | 35% | 50-70% compression | 35% × 60% | 21% |
| C Group | 30% | Complete discard | 30% × 100% | 30% |
| Total | 100% | | | 57.25% |

With aggressive B Group compression (70%), total memory savings can reach:
B Group contribution: 35%×70%=24.5%
Total: 0%+6.25%+24.5%+30%=60.75%
   In highly optimized deployments with maximum compression rates (A: 30%, B: 70%), memory savings can reach approximately 62%.

### 10.8.4 Response Time Improvement

Database cache miss penalty is typically 10-100× cache hit latency due to disk I/O and query execution overhead. Using a conservative 10× multiplier, response time improvement follows the same formula:
Baseline average latency: L₁=H₁(1)+(1−H₁)(10)
Optimized average latency: L₂=H₂(1)+(1−H₂)(10)
Improvement: (L₁−L₂)/L₁
   For example, if importance-based classification improves hit rate by 25 percentage points:

| Baseline Hit | Optimized Hit | Baseline | Optimized | |
|---|---|---|---|---|
| Rate (H₁) | Rate (H₂) | Latency | Latency | Improvement |
| 55% | 80% | 5.05 units | 2.8 units | 45% |
| 65% | 90% | 4.15 units | 1.9 units | 54% |
| 75% | 100% | 3.25 units | 1.0 units | 69% |

Actual improvement varies based on baseline hit rate and database system-specific cache miss penalty.

### 10.8.5 Summary

This embodiment demonstrates the invention applied to database caching:
1. Classification: Query results and database objects distributed into S/A/B/C groups based on access criticality
2. Differential processing: Critical authentication and session data preserved; expired temporary data discarded
3. Memory savings: Calculated savings of approximately 57-62% based on group distribution and compression rates
4. Response time: Improvements derived directly from cache hit rate enhancement, with potentially higher gains due to expensive database operations
   The calculation methodology maintains consistency with other embodiments while adapting to database-specific data characteristics.

### 10.9 Embodiment 3: E-Commerce Platform

### 10.9.1 System Configuration

In this exemplary embodiment, the cache flow control system is deployed in an e-commerce platform managing product catalogs, user sessions, and transaction data. The system applies S/A/B/C classification to optimize cache utilization during high-traffic periods such as promotional events while ensuring critical transaction data integrity.

### 10.9.2 Classification Distribution

The priority evaluation unit (130) classifies e-commerce cache entries based on business criticality and access patterns. For example, in one deployment:
S Group (~20%, higher than other embodiments due to transaction integrity requirements): Active shopping carts, payment processing state, inventory locks, user authentication tokens
A Group (~25%): Product details for trending items, user browsing history, personalization data
B Group (~30%): Product reviews, recommendation engine results, historical order summaries
C Group (~25%, lower than other embodiments due to inability to discard critical data): Expired promotions, outdated price snapshots, abandoned session fragments
   These distribution percentages are exemplary and may vary based on specific platform characteristics and seasonal traffic patterns.

### 10.9.3 Memory Savings Calculation

Applying differential processing strategies to the above distribution, memory savings are calculated as follows:

| Group | Population | Processing Strategy | Calculation | Savings |
|---|---|---|---|---|
| S Group | 20% | Full preservation | 20% × 0% | 0% |
| A Group | 25% | 20-30% compression | 25% × 25% | 6.25% |
| B Group | 30% | 50-70% compression | 30% × 60% | 18% |
| C Group | 25% | Complete discard | 25% × 100% | 25% |
| Total | 100% | | | 49.25% |

With aggressive B Group compression (70%), total memory savings can reach:
B Group contribution: 30%×70%=21%
Total: 0%+6.25%+21%+25%=52.25%
   In highly optimized deployments with maximum compression rates (A: 30%, B: 70%), memory savings can reach approximately 54%.
   Note: E-commerce deployments typically show lower memory savings (approximately 49-54%) compared to conversational AI systems (approximately 58-62%) due to the higher S Group allocation required for transaction integrity.

### 10.9.4 Response Time Improvement

E-commerce cache miss penalty varies by data type, ranging from 5× for simple lookups to 50× for complex recommendation queries. Using a conservative 10× multiplier for average operations, response time improvement follows the same formula:
Baseline average latency: L₁=H₁(1)+(1−H₁)(10)
Optimized average latency: L₂=H₂(1)+(1−H₂)(10)
Improvement: (L₁−L₂)/L₁
   For example, if importance-based classification improves hit rate by 20 percentage points:

| Baseline Hit | Optimized Hit | Baseline | Optimized | |
|---|---|---|---|---|
| Rate (H₁) | Rate (H₂) | Latency | Latency | Improvement |
| 60% | 80% | 4.6 units | 2.8 units | 39% |
| 70% | 90% | 3.7 units | 1.9 units | 49% |
| 80% | 100% | 2.8 units | 1.0 units | 64% |

Actual improvement varies based on baseline hit rate and specific cache miss penalty for different operation types.

### 10.9.5 Summary

This embodiment demonstrates the invention applied to e-commerce caching:
1. Classification: Transaction data and product information distributed into S/A/B/C groups based on business criticality
2. Differential processing: Active carts and payment state preserved; expired promotions and abandoned sessions discarded
3. Memory savings: Calculated savings of approximately 49-54% based on group distribution and compression rates
4. Response time: Improvements derived directly from cache hit rate enhancement
   The calculation methodology maintains consistency with other embodiments while adapting to e-commerce-specific requirements for transaction data protection.

### 10.10 Embodiment 4: Mobile Application

### 10.10.1 System Configuration

In this exemplary embodiment, the cache flow control system is deployed in a mobile application operating under strict memory and power constraints. The system applies S/A/B/C classification to optimize limited device resources while maintaining responsive user experience across varying network conditions.

### 10.10.2 Classification Distribution

The priority evaluation unit (130) classifies mobile cache entries based on user experience impact and resource constraints. For example, in one deployment:
S Group (~10%, minimized due to strict memory constraints on mobile devices): Active user session, authentication credentials, currently displayed content
A Group (~20%): Recently accessed screens, user preferences, offline-essential data
B Group (~30%): Pre-fetched content, background sync data, cached API responses
C Group (~40%, maximized to aggressively free memory for foreground operations): Thumbnail caches, expired push notifications, outdated location data, previous session artifacts
   These distribution percentages are exemplary and may vary based on specific device capabilities and application requirements.

### 10.10.3 Memory Savings Calculation

Applying differential processing strategies to the above distribution, memory savings are calculated as follows:

| Group | Population | Processing Strategy | Calculation | Savings |
|---|---|---|---|---|
| S Group | 10% | Full preservation | 10% × 0% | 0% |
| A Group | 20% | 20-30% compression | 20% × 25% | 5% |
| B Group | 30% | 50-70% compression | 30% × 60% | 18% |
| C Group | 40% | Complete discard | 40% × 100% | 40% |
| Total | 100% | | | 63% |

With aggressive B Group compression (70%), total memory savings can reach:
B Group contribution: 30%×70%=21%
Total: 0%+5%+21%+40%=66%
   In highly optimized deployments with maximum compression rates (A: 30%, B: 70%), memory savings can reach approximately 67%.
   Note: Mobile deployments typically show higher memory savings (approximately 63-67%) compared to other embodiments due to aggressive C Group allocation necessitated by device memory constraints.

### 10.10.4 Response Time Improvement

Mobile cache miss penalty varies significantly with network conditions, ranging from 5× on fast WiFi to 100× on slow cellular connections. Using an intermediate 15× multiplier reflecting mixed network conditions, response time improvement is calculated as:

$$\begin{matrix}\begin{matrix}Baseline average latency : & {L}_{1} = {H}_{1} ( 1 ) + ( 1 - {H}_{1} ) ( 15 )\end{matrix} \\ \begin{matrix}Optimized average latency : & {L}_{2} = {H}_{2} ( 1 ) + ( 1 - {H}_{2} ) ( 15 )\end{matrix} \\ \begin{matrix}Improvement : & ( {L}_{1} - {L}_{2} ) / {L}_{1}\end{matrix}\end{matrix}$$

For example, if importance-based classification improves hit rate by 25 percentage points:

| Baseline Hit | Optimized Hit | Baseline | Optimized | |
|---|---|---|---|---|
| Rate (H₁) | Rate (H₂) | Latency | Latency | Improvement |
| 50% | 75% | 8.0 units | 4.5 units | 44% |
| 60% | 85% | 6.6 units | 3.1 units | 53% |
| 70% | 95% | 5.2 units | 1.7 units | 67% |

Actual improvement varies based on baseline hit rate and network conditions. In poor network conditions with higher cache miss penalty, improvements can be substantially greater.

### 10.10.5 Summary

This embodiment demonstrates the invention applied to mobile caching:
1. Classification: Mobile cache entries distributed into S/A/B/C groups based on user experience impact and resource constraints
2. Differential processing: Active sessions and displayed content preserved; expired notifications and previous session artifacts aggressively discarded
3. Memory savings: Calculated savings of approximately 63-67% based on group distribution and compression rates
4. Response time: Improvements derived directly from cache hit rate enhancement, with potentially higher gains in poor network conditions
   The calculation methodology maintains consistency with other embodiments while adapting to mobile-specific constraints requiring aggressive memory optimization.

### 10.11 Comparative Analysis of Embodiments

The four embodiments demonstrate the versatility and consistent effectiveness of the importance-based cache flow control system across diverse application domains. While implementation details vary according to domain-specific requirements, all embodiments share fundamental characteristics: S/A/B/C classification based on importance rather than recency, differential processing based on group assignment, and systematic calculation methodology for performance estimation.

### 10.11.1 Cross-Domain Performance Comparison

Memory savings calculations show consistency across all deployment scenarios while reflecting domain-specific characteristics:

| | S | C | Memory | Key |
|---|---|---|---|---|
| Embodiment | Group | Group | Savings | Characteristic |
| Conversational AI | 15% | 35% | approximately | Baseline |
| (10.7) | | | 58-62% | distribution |
| Database Caching | 10% | 30% | approximately | Authentication |
| (10.8) | | | 57-62% | data emphasis |
| E-commerce | 20% | 25% | approximately | Transaction |
| (10.9) | | | 49-54% | integrity |
| | | | | priority |
| Mobile Application | 10% | 40% | approximately | Aggressive |
| (10.10) | | | 63-67% | memory |
| | | | | optimization |

The variation in memory savings across embodiments directly reflects each domain's S/A/B/C group distribution requirements:
Conversational AI achieves approximately 58-62% savings using baseline distribution
Database systems allocate less to S Group (authentication data is small) and maintain substantial C Group for expired sessions
E-commerce platforms require higher S Group allocation (20%) for transaction integrity, resulting in lower overall savings (approximately 49-54%)
Mobile applications maximize C Group allocation (40%) for aggressive memory management, achieving the highest savings (approximately 63-67%)

### 10.11.2 Calculation Methodology Consistency

All embodiments apply the same calculation methodology:

### Memory Savings Formula:

$$Total Savings = \sum ( Group Population \times Processing Rate )$$

### Where:

S Group: 0% processing (full preservation)
A Group: 20-30% compression
B Group: 50-70% compression
C Group: 100% discard

### Response Time Improvement Formula:

$$Improvement = ( {L}_{1} - {L}_{2} ) / {L}_{1}$$

### Where:

L₁=H₁(1)+(1−H₁)(P) [baseline]
L₂=H₂(1)+(1−H₂)(P) [optimized]
P=Cache miss penalty (10× for most systems, 15× for mobile)
   This consistent methodology enables systematic performance estimation across diverse deployment scenarios while allowing for domain-specific parameter adjustments.

### 10.11.3 Advantages Over Traditional Approaches

All embodiments address the fundamental limitation of time-based caching (LRU/LFU): access timing alone cannot distinguish important information from unimportant information.
Conversational AI Project requirements from early in a conversation (S Group) remain accessible throughout extended sessions regardless of recency, while acknowledgments and repetitive content (C Group) are immediately discarded.
Database Systems: Expensive queries and authentication data (S Group) receive protection from eviction by low-value frequent queries, while expired sessions and temporary calculations (C Group) are discarded.
E-commerce Platforms: Active carts and payment state (S Group) receive guaranteed preservation for transaction integrity, while expired promotions and abandoned sessions (C Group) are removed.
Mobile Applications: Active sessions and displayed content (S Group) remain immediately accessible regardless of network conditions, while expired notifications and previous session artifacts (C Group) are aggressively discarded to conserve device resources.

The four embodiments demonstrate that the same S/A/B/C classification framework provides consistent benefits across diverse applications through domain-specific distribution parameter adjustments.

### DESCRIPTION OF REFERENCE NUMERALS

### FIG. 1: Cache Flow Control System Utilizing S/A/B/C Group Classification

110: User Input Unit
120: Cache Memory Unit
130: Priority Evaluation Unit
140: S Group Preservation Processing Unit
150: A Group Compression Processing Unit
160: B Group Compression/Deletion Processing Unit
170: C Group Disposal Processing Unit
180: Context Restoration Unit
190: Response Generation Unit

### FIG. 2: Priority-Based Cache Management Process

210: User Input Unit
220: Cache Entry Evaluation Unit
230: Priority Group Allocation Unit
240: S Group Preservation Unit
250: A Group Compression Unit
260: B Group Compression/Deletion Unit
270: C Group Disposal Unit
280: Memory Update Unit
290: Information Flow Continuation Unit

### FIG. 3: Context-Based Restoration Process During Cache Restoration

310: Missing Context Detection Unit
320: Priority Group Evaluation Unit
330: S Group Complete Restoration Unit
340: A Group Summary Restoration Unit
350: B Group Selective Restoration Unit
360: C Group Skip Unit
370: Transition Phrase Insertion Unit
380: Context Reconstruction Unit
390: Information Flow Continuation Unit

What is claimed is:

1. A cache flow control system for classifying and processing data according to information importance, the system comprising:
an input unit that receives user input data;
a cache memory evaluation unit that analyzes, in real time, information importance, repeatability, and flow conflict status of data records;
a priority group assignment unit that classifies data into the following groups according to the importance analyzed by the cache memory evaluation unit:
S group: core information to be completely maintained without deletion or compression,
A group: important information that can be summarized but whose essential information is maintained,
B group: auxiliary information maintained according to compression or deletion conditions, and
C group: incidental information that can be discarded in real time;
a group rule application unit that applies a processing method suitable for characteristics of each group by:
preserving the S group,
summarizing the A group,
compressing or deleting the B group, and
discarding the C group; and
a memory update unit that stores and manages the processed information in an optimized form in the cache memory.

2. The cache flow control system of claim 1, wherein the input unit includes a data preprocessing module that pre-analyzes received data and assigns processing priorities.

3. The cache flow control system of claim 1, wherein the cache memory evaluation unit monitors cache state parameters to determine an optimal timing for cache management, and wherein the cache state parameters include at least one of system memory usage, amount of data being processed, and user interaction patterns.

4. The cache flow control system of claim 1, wherein the priority group assignment unit analyzes data characteristic indicators to quantify importance of data and classifies the data into the S, A, B, and C groups according to the quantified importance, and wherein the data characteristic indicators include at least one of data access frequency, usage recency, semantic importance, and association with other data.

5. The cache flow control system of claim 1, wherein the group rule application unit includes an adaptive rule application mechanism that dynamically adjusts group-specific processing criteria according to system operating conditions, and wherein the system operating conditions include at least one of cache memory capacity, system performance status, and user activity patterns.

6. The cache flow control system of claim 1, wherein the memory update unit includes a space optimization function that applies data placement algorithms for cache memory space optimization by physically placing related data adjacently.

7. The cache flow control system of claim 1, further comprising:
a compression analysis module that analyzes data compression evaluation indicators; and
an adaptive compression module that dynamically adjusts group classification criteria and compression strength based on the analysis results,
wherein the data compression evaluation indicators include at least one of data characteristics, repetition patterns, information distribution, and system resource availability.

8. The cache flow control system of claim 1, further comprising a differential restoration module that detects and restores missing context by:
performing complete restoration for the S group,
performing restoration with summary for the A group,
performing selective restoration for the B group, and
skipping restoration for the C group.

9. The cache flow control system of claim 1, further comprising a context preservation module that:
stores low-importance data from past information in a cache circular queue,
maintains core information, and
automatically presents the most recent core information to prevent overall context loss.

10. The cache flow control system of claim 1, further comprising a repetitive pattern management module that:
automatically detects repetitive user utterances,
selectively moves them to a cache circular queue according to importance classification, and
reflects only core information in the current data.

11. The cache flow control system of claim 1, further comprising a context restoration unit that automatically inserts linking sentences or linking information when restoring past information to prevent context discontinuity.

12. The cache flow control system of claim 11, wherein the context restoration unit includes an intelligent context inference module that uses intelligent analysis technology to infer the context of deleted or compressed information and automatically generate linking context, and wherein the intelligent analysis technology includes at least one of an artificial intelligence model, a machine learning algorithm, and a rule-based inference system.

13. The cache flow control system of claim 1, wherein the priority group assignment unit:
includes an importance calculation engine that calculates importance of data using at least one of a machine learning model, a statistical analysis algorithm, and a rule-based analysis system,
classifies the data into the S, A, B, and C groups according to an importance score calculated by the importance calculation engine, and
automatically improves classification accuracy by learning from past classification results and system performance data.

14. The cache flow control system of claim 1, wherein:
the cache flow control system is implemented with various cache structures,
the group rule application unit includes a cache structure adaptation module that optimizes data storage and management methods according to an applied cache structure,
the cache structure includes at least one of a hierarchical cache structure, a distributed cache structure, and an integrated cache structure,
in the hierarchical cache structure, the S group data is placed in a highest level cache, the A group data is placed in a middle level cache, the B group data is placed in a lower level cache, and the C group data is excluded from the cache,
in the distributed cache structure, the S group and A group data are replicated to all nodes, the B group data is stored only in selected nodes according to access frequency, and the C group data is recorded only in temporary storage, and
in the integrated cache structure, memory space is dynamically allocated in proportion to importance of the S, A, B, and C groups, and data location is readjusted according to recent usage frequency and access patterns within each group.

15. The cache flow control system of claim 1, wherein the priority group assignment unit includes a dynamic adjustment module that:
monitors, in real time, at least one of system load status, user demand patterns, and data access characteristics,
automatically adjusts boundary values between the S, A, B, and C groups based on monitoring results, and
optimizes a memory allocation ratio for each group according to current work load and expected data access patterns to improve a cache hit rate.
